(19) United States
(12) Patent Application Publication
(10) Pub. No.: US 2026/0348451 A1
(43) Pub. Date: Nov. 5, 2026

(54) SPEED REDUCER

(71) Applicant: NABTESCO CORPORATION, Tokyo (JP)

(72) Inventors: Koichi NANDATE, Tokyo (JP); Kazuyoshi MAKISUMI, Tokyo (JP); Yoshiaki MAKIZOE, Tokyo (JP)

(21) Appl. No.: 19/655,325

(22) Filed: Apr. 22, 2026

(30) Foreign Application Priority Data
May 1, 2025 (JP) 2025-076311

(51) Int. Cl. F16H 1/32

(52) U.S. Cl. CPC F16H 1/32; F16H 2001/325

(57) ABSTRACT

A speed reducer includes: a case having internal teeth; a carrier rotatable relative to the case and including first and second carrier members; an external gear having external teeth that mesh with the internal teeth, the external gear having a central hole and a plurality of through holes arranged around the central hole; a shaft member rotatably supported by the carrier; and a plurality of carrier pins inserted in the through holes to connect the first carrier member and the second carrier member, each carrier pin including a head, a shaft portion, and a connecting portion, the connecting portion having a concave curved shape that connects the head and the shaft portion and whose width gradually decreases. The radius of curvature of the connecting portion at a given position differs from the radius of curvature at another given position displaced from the given position in an axial direction.

### CROSS-REFERENCE TO RELATED APPLICATIONS

This application is based on and claims the benefit of priority from Japanese Patent Application Serial No. 2025-076311 (filed on May 1, 2025), the contents of which are hereby incorporated by reference in its entirety.

### TECHNICAL FIELD

The present disclosure relates to a speed reducer.

### BACKGROUND

Japanese Patent Application Publication No. 2017-82993 discloses an eccentric oscillating-type speed reducer. The eccentric oscillating-type speed reducer includes a case, a carrier, an external gear, a shaft member, and a plurality of carrier pins. The case has internal teeth that mesh with external teeth of the external gear. The carrier includes a first carrier member and a second carrier member connected by the plurality of carrier pins. The case and the carrier are rotatable relative to each other. The shaft member has an eccentric member disposed in a central hole of the external gear and is rotatably supported by the carrier. The external gear eccentrically oscillates by rotation of the shaft member. Each carrier pin is inserted in a through-hole in the external gear. The speed reducer can reduce the number of rotations input to the shaft member and output the reduced rotations as relative rotations of the case and the carrier.

The carrier pin includes a head, a shaft portion having a smaller width than the head, and a connecting portion connecting the head and the shaft portion. The connecting portion is provided to prevent stress from concentrating in a portion between the head and the shaft portion during the operation of the speed reducer, which could cause breakage of the carrier pin. Thus, the connecting portion has a concave curved shape with a gradually decreasing width. Increasing the radius of curvature of the connecting portion can suppress stress concentration, but weakens an axial force of the carrier pin. Decreasing the radius of curvature of the connecting portion allows a greater axial force, but leads to the stress concentration in the connecting portion. Consequently, it has been difficult to achieve both the sufficient axial force of the carrier pin and the suppression of stress concentration in the connecting portion.

One object of the disclosure is to ensure the sufficient axial force of the carrier pin included in the speed reducer while suppressing stress concentration in the connecting portion of the carrier pin.

### SUMMARY

A speed reducer according to one embodiment of the disclosure includes: a case having internal teeth; a carrier including a first carrier member and a second carrier member, the carrier being rotatable relative to the case; an external gear disposed between the first carrier member and the second carrier member, the external gear having external teeth that mesh with the internal teeth, and the external gear having a central hole and a plurality of through holes arranged around the central hole; a shaft member having an eccentric member disposed in the central hole, the shaft member being rotatably supported by the carrier; and a plurality of carrier pins inserted in the through holes to connect the first carrier member and the second carrier member, each carrier pin including a head, a shaft portion whose width is smaller than a width of the head, and a connecting portion, the connecting portion having a concave curved shape that connects the head and the shaft portion and whose width gradually decreases. The radius of curvature of a surface of the connecting portion at a given position differs from the radius of curvature of a surface of the connecting portion at another given position displaced from the given position in an axial direction.

### ADVANTAGEOUS EFFECTS

According to the aspect of the disclosure, it is possible to ensure the sufficient axial force of the carrier pin included in the speed reducer while suppressing stress concentration in the connecting portion of the carrier pin.

### BRIEF DESCRIPTION OF THE DRAWINGS

FIG. 1 is a longitudinal sectional view of a speed reducer for describing an embodiment of the present disclosure.

FIG. 2 is a sectional view taken along the line II-II in FIG. 1.

FIG. 3 is a longitudinal sectional view of a carrier pin included in the speed reducer of FIG. 1.

FIG. 4 is a partially enlarged view of FIG. 3, showing a specific example of a connecting portion of the carrier pin.

FIG. 5 is a partially enlarged view of FIG. 3, showing another specific example of the connecting portion of the carrier pin.

FIG. 6 is a partially enlarged view of FIG. 3, showing yet another specific example of the connecting portion of the carrier pin.

### DESCRIPTION OF THE EMBODIMENTS

An embodiment of the disclosure relates to the following items <1> to <5>.

<1> A speed reducer including:
a case having internal teeth;
a carrier including a first carrier member and a second carrier member, the carrier being rotatable relative to the case;
an external gear disposed between the first carrier member and the second carrier member, the external gear having external teeth that mesh with the internal teeth, and the external gear having a central hole and a plurality of through holes arranged around the central hole;
a shaft member having an eccentric member disposed in the central hole, the shaft member being rotatably supported by the carrier; and
a plurality of carrier pins inserted in the through holes to connect the first carrier member and the second carrier member, each carrier pin including a head, a shaft portion whose width is smaller than a width of the head, and a connecting portion, the connecting portion having a concave curved shape that connects the head and the shaft portion and whose width gradually decreases,
wherein a radius of curvature of a surface of the connecting portion at a given position differs from a radius of curvature of a surface of the connecting portion at another given position displaced from the given position in an axial direction.

<2> The speed reducer of Item <1>, wherein the given position is situated between the head and the other given position in the axial direction, and
wherein the radius of curvature of the surface at the given position is smaller than the radius of curvature of the surface at the other given position.

<3> The speed reducer of Item <1>, wherein the connecting portion includes a first connecting portion having an outer contour along an arc, and a second connecting portion having an outer contour along an arc with a radius of curvature different from a radius of curvature of the first connecting portion,
wherein the first connecting portion is disposed between the head and the second connecting portion in the axial direction, and
the radius of curvature of the first connecting portion is smaller than the radius of curvature of the second connecting portion.

<4> The speed reducer of Item <1>, wherein the radius of curvature of the connecting portion decreases in the axial direction from the shaft portion toward the head.

<5> The speed reducer of any one of Items <1> to <4>, wherein the width of the shaft portion is 68 % or more of the width of the head.

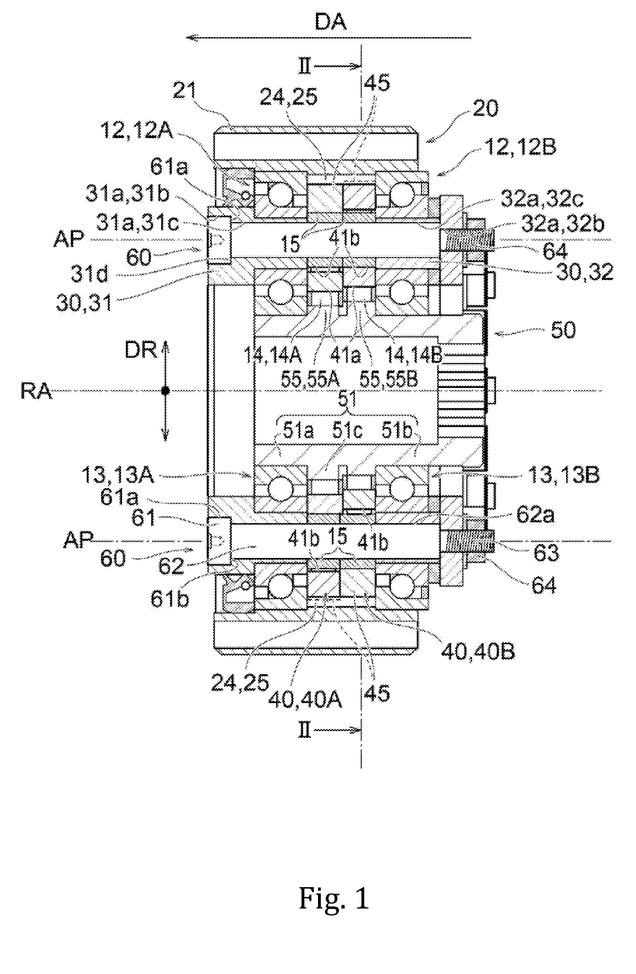

With reference to the appended drawings, the following describes one embodiment of the present disclosure. FIGS. 1 to 6 are provided for describing one embodiment of the present disclosure. The features and components shown in one or more of the drawings may not be shown in other drawings. The drawings may have different scales and aspect ratios.

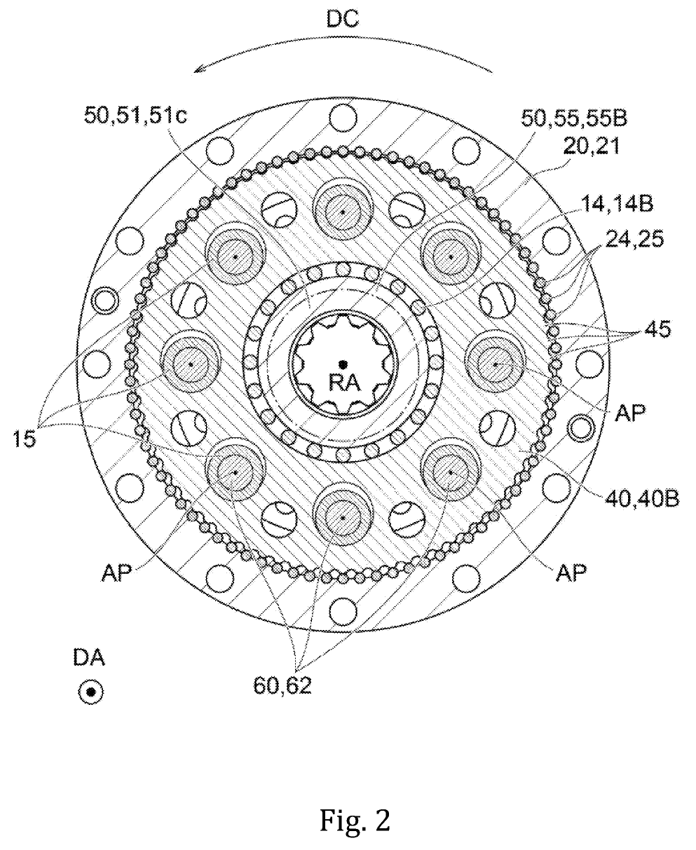

To clarify the relationships between directions across the drawings, arrows marked with common symbols are provided to indicate the common axial direction DA, circumferential direction DC, radial direction DR, and pin radial direction DRP. The tip of the arrow indicates a first side of each direction. The side opposite the tip of the arrow indicates a second side of each direction. An arrow pointing toward the viewer along a direction perpendicular to the plane of the drawing is indicated by a circled dot, as shown in FIG. 2, for example.

The following now describes the overall configuration of a speed reducer 10 with reference to FIGS. 1 and 2. FIG. 1 is a longitudinal sectional view of the speed reducer 10. FIG. 2 is a sectional view of the speed reducer 10 taken along the line II-II in FIG. 1.

The speed reducer 10 receives rotation input by a drive unit such as a motor. The speed reducer 10 reduces the input rotation and outputs the reduced rotation. The speed reducer 10 includes, as its main components, a case 20, a carrier 30, an external gear 40, a shaft member 50, and a plurality of carrier pins 60. The case 20 houses the carrier 30 therein. A first bearing 12 may be provided between the case 20 and the carrier 30. The case 20 and carrier 30 are rotatable relative to each other about a rotational axis RA. The speed reducer 10 reduces the input rotation and outputs the reduced rotation in the form of the relative rotation of the case 20 and the carrier 30. The direction parallel to the rotational axis RA is referred to as an axial direction DA. The carrier 30 houses the shaft member 50. The carrier 30 and the shaft member 50 are rotatable relative to each other about the rotational axis RA. A second bearing 13 may be provided between the carrier 30 and the shaft member 50. The drive unit inputs rotation to the shaft member 50. The shaft member 50 has an eccentric member 55. The center of the eccentric member 55 is off the center of rotation of the shaft member 50. The external gear 40 is penetrated by the shaft member 50. The external gear 40 is disposed on the eccentric member 55. As the shaft member 50 rotates, the external gear 40 eccentrically oscillates. The external gear 40 has external teeth 45 that mesh with internal teeth 25 formed on the inner surface of the case 20. The number of the internal teeth 25 is different from the number of the external teeth 45. Once rotation is input into the shaft member 50, the external gear 40 eccentrically oscillates while the internal and external teeth 25 and 45 mesh with each other. Due to the difference in the number of teeth between the internal teeth 25 and the external teeth 45, the external gear 40 rotates relative to the case 20. The plurality of carrier pins 60 are inserted in through-holes 43 of the external gear 40. The external gear 40 is supported by the plurality of carrier pins 60. The plurality of carrier pins 60 are held by the carrier 30. As the external gear 40 rotates relative to the case 20, the carrier 30, which holds the multiple carrier pins 60, rotates relative to the case 20.

The following describes in detail the case 20, carrier 30, external gear 40, shaft member 50, and carrier pins 60 and their specific configurations shown in the drawings.

The case 20 has the internal teeth 25. The internal teeth 25 are arranged in a circumferential direction DC about the rotational axis RA. In the illustrated example, the speed reducer 10 has two external gears 40A and 40B arranged next to each other in the axial direction DA. The internal teeth 25 each extend in the axial direction DA and mesh with the external teeth 45 of the two external gears 40A and 40B.

As illustrated, the case 20 includes a substantially cylindrical case body 21 and internal tooth pins 24 held on the inner surface of the case body 21. The case body 21 has a plurality of pin grooves arranged along the circumferential direction DC. The pin grooves extend in the axial direction DA to receive and hold the cylindrical internal tooth pins 24. Each internal tooth pin 24 serves as one internal tooth 25.

The carrier 30 is held in the case 20 via a pair of the first bearings 12. The carrier 30 is rotatable relative to the case 20 about the rotational axis RA. The carrier 30 shown in the drawings includes a first carrier member 31 and a second carrier member 32. The first carrier member 31 and the second carrier member 32 are arranged at a distance from each other in the axial direction DA. In the illustrated example, the first carrier member 31 is disposed on the first side relative to the second carrier member 32 in the axial direction DA. The first carrier member 31 and the second carrier member 32 are connected by a plurality of carrier pins 60. The plurality of carrier pins 60 pass through the first carrier member 31 and the second carrier member 32. The plurality of carrier pins 60 prevent the first carrier member 31 and the second carrier member 32 from rotating relative to each other about the rotational axis RA.

As shown in FIG. 1, the first carrier member 31 has a cylindrical shape centered at the rotational axis RA. One of the pair of first bearings 12, which is a first bearing 12A, is provided between the first carrier member and the case 20. The first carrier member 31 is rotatably supported by case 20 via the first bearing 12A.

As shown in FIG. 1, the first carrier member 31 is provided with a plurality of first pin holes 31a that extend therethrough in the axial direction DA. The plurality of first pin holes 31a are arranged at equal intervals in the circumferential direction DC. Each first pin hole 31a includes a head hole 31b and a first shaft hole 31c. The width of the head hole 31b is greater than the width of the first shaft hole 31c. In the illustrated example, the head hole 31b is situated on the first side in the axial direction DA relative to the first shaft hole 31c. In the illustrated example, the first shaft hole 31c is situated on the second side relative to the head hole 31b in the axial direction DA. Each first pin hole 31a includes a pin support surface 31d extending annularly between the head hole 31b and the first shaft hole 31c. In the illustrated example, the head hole 31b and the first shaft hole 31c are formed by cylindrical surfaces. The inner diameter of the head hole 31b is larger than the inner diameter of the first shaft hole 31c.

In the illustrated example, the pin support surface 31d is a plane perpendicular to the axial direction DA.

As shown in FIG. 1, the second carrier member 32 has a cylindrical shape centered at the rotational axis RA. The other of the pair of first bearings 12, which is a first bearing 12B, is provided between the second carrier member and the case 20. The second carrier member 32 is rotatably supported by the case 20 via the first bearing 12B.

As shown in FIG. 1, the second carrier member 32 is provided with a plurality of second pin holes 32a that extend therethrough in the axial direction DA. The plurality of second pin holes 32a are arranged at equal intervals in the circumferential direction DC. Each second pin hole 32a includes a bolt hole 32b and a second shaft hole 32c. The width of the second shaft hole 32c is greater than the width of the bolt hole 32b. In the illustrated example, the bolt hole 32b is situated on the second side in the axial direction DA relative to the second shaft hole 32c. In the illustrated example, the second shaft hole 32c is situated on the first side relative to the bolt hole 32b in the axial direction DA. In the illustrated example, the bolt hole 32b and the second shaft hole 32c are formed by cylindrical surfaces. The inner diameter of the second shaft hole 32c is greater than the inner diameter of the bolt hole 32b. Furthermore, the portion of the second carrier member 32 where the bolt hole 32b is formed and the portion of the second carrier member 32 where the second shaft hole 32c is formed may be separate components.

The number of the first pin holes 31a is the same as the number of the second pin holes 32a. The distance of the first pin holes 31a from the rotational axis RA is the same as the distance of the second pin holes 32a from the rotational axis RA. The width of the first shaft hole 31c is the same as the width of the second shaft hole 32c.

The shaft member 50 is held in the carrier 30 via a pair of the second bearings 13. The shaft member 50 is rotatable relative to the carrier 30 about the rotational axis RA. As shown in FIG. 1, the shaft member 50 may be cylindrical in shape. The shaft member 50 receives rotational input from a drive means such as a motor. A spline for transmitting rotation to the shaft member 50 may be provided on the inner surface of the cylindrical shaft member 50.

The shaft member 50 includes a shaft body portion 51 and a pair of eccentric members 55. The pair of eccentric members 55 is disposed on the shaft body portion 51. The eccentric members 55 have an annular shape. The center of the outer diameter of the eccentric members 55 is eccentrically offset from the rotational axis RA in the radial direction DR. The pair of eccentric members 55 include a first eccentric member 55A and a second eccentric member 55B. The first eccentric member 55A and the second eccentric member 55B are offset by the same amount from the rotational axis RA in opposite directions. In other words, the center of the outer diameter of the first eccentric member 55A and the center of the outer diameter of the second eccentric member 55B are in point-symmetrical positions with respect to a single point on the rotational axis RA.

The shaft body portion 51 may have a cylindrical shape about the rotational axis RA. The shaft body portion 51 includes a first bearing support portion 51a, a second bearing support portion 51b, and an eccentric member holding portion 51c. In the illustrated example, the first bearing support portion 51a, the eccentric member holding portion 51c, and the second bearing support portion 51b are arranged in this order from the first side to the second side in the axial direction DA. The eccentric member holding portion 51c is positioned between the first bearing support portion 51a and the second bearing support portion 51b.

The first bearing support portion 51a is inserted into the first carrier member 31. One of the pair of second bearings 13, which is a second bearing 13A, is provided between the first bearing support portion 51a and the first carrier member 31. Via the second bearing 13A, the first carrier member 31 and the shaft member 50 are rotatable relative to each other.

The second bearing support portion 51b is inserted into the second carrier member 32. The other of the pair of second bearings 13, which is a second bearing 13B, is provided between the second bearing support portion 51b and the second carrier member 32. Via the second bearing 13B, the second carrier member 32 and the shaft member 50 are rotatable relative to each other. A spline may be provided on the inner surface of the second bearing support portion 51b.

A pair of eccentric members 55A and 55B are provided on the eccentric member holding portion 51c. The pair of eccentric members 55A and 55B are disposed between the pair of second bearings 13. In the illustrated example, one of the second bearings 13A, the first eccentric member 55A, the second eccentric member 55B, and the other second bearing 13B are arranged in this order from the first side to the second side in the axial direction DA.

The illustrated speed reducer 10 includes a first external gear 40A and a second external gear 40B as the external gears 40. The first external gear 40A and the second external gear 40B are disposed between the first carrier member 31 and the second carrier member 32. In the illustrated example, the first carrier member 31, the first external gear 40A, the second external gear 40B, and the second carrier member 32 are arranged in this order from the first side to the second side in the axial direction DA.

The illustrated external gear 40 has a disk-shaped central plate 41 and external teeth 45 arranged around the periphery of the central plate 41. The central plate has a center hole 41a and through holes 41b. The central hole 41a is situated on the rotational axis RA. In the illustrated example, the multiple through holes 41b are arranged at equal intervals around the central hole 41a, at a fixed distance from the center of the central hole 41a.

The eccentric member 55 is disposed within the central hole 41a. A roller bearing 14 is provided between the eccentric member 55 and the external gear 40. In the illustrated example, the first external gear 40A is supported on the first eccentric member 55A via a first roller bearing 14A. In the illustrated example, the second external gear 40B is supported on the second eccentric member 55B via a second roller bearing 14B.

The through hole 41b faces either the first pin hole 31a or the second pin hole 32a. In the illustrated example, the first pin hole 31a, the through hole 41b of the first external gear 40A, the through hole 41b of the second external gear 40B, and the second pin hole 32a are arranged in that order from the first side to the second side in the axial direction DA. The number of the through holes 41b in each external gear 40 is the same as the number of the first pin holes 31a.

The number of the through holes 41b in each external gear 40 is the same as the number of the second pin holes 32a.

The external teeth 45 mesh with the internal teeth 25 of the case 20. The number of the external teeth 45 is fewer than the number of the internal teeth 25. In the illustrated example, the number of the external teeth 45 is one fewer than the number of the internal teeth 25.

As the shaft member 50 rotates, the external gear 40 eccentrically oscillates. More specifically, as the shaft member 50 rotates relative to the carrier 30, the external gear 40 translates relative to the carrier 30 and moves in a circular path centered on the rotational axis RA. The first and second external gears 40A and 40B are shifted by half a phase.

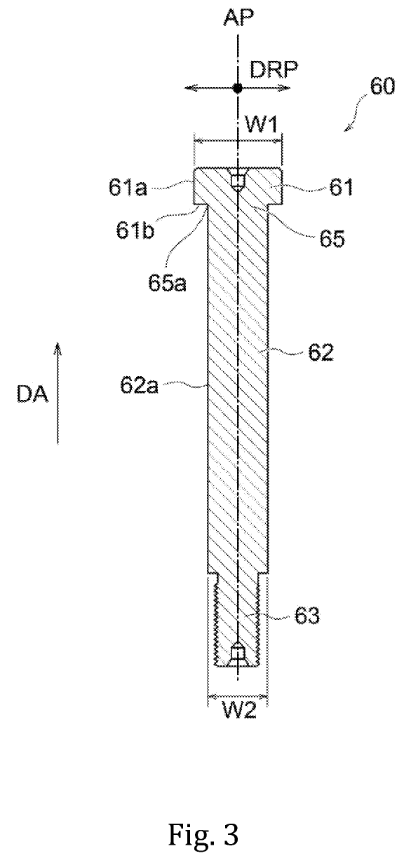

The plurality of carrier pins 60 connect the first carrier member 31 and the second carrier member 32. The plurality of carrier pins 60 are fixed to the carrier 30. Each carrier pin 60 is rod-shaped, with a pin axis AP parallel to the axial direction DA serving as its central axis. The plurality of pin axes AP are arranged at equal intervals along the circumferential direction DC. In other words, the plurality of pin axes AP are disposed at equal intervals on a circle centered on the rotational axis RA. The carrier pin 60 is inserted in the first pin hole 31a, the pair of through holes 41b, and the second pin hole 32a. As shown in FIGS. 1 and 3, the carrier pin 60 includes a head 61, a shaft portion 62 whose width is smaller than the width of the head 61, and a bolt portion 63 whose width is smaller than the shaft portion 62. The head 61, the shaft 62, and the bolt 63 are arranged in this order from the first side to the second side in the axial direction DA. The shaft 62 is disposed between the head 61 and the bolt portion 63.

The head 61 is received in the head hole 31b of the first carrier member 31. The shaft portion 62 is inserted in sequence into the first shaft hole 31c, the through hole 41b of the first external gear 40A, the through hole 41b of the second external gear 40B, and the second shaft hole 32c. The bolt portion 63 is inserted in the bolt hole 32b of the second carrier member. The bolt portion 63 is longer than the bolt hole 32b. Therefore, as shown in FIG. 1, a nut 64 engages with the portion of the bolt portion 63 protruding from the bolt hole 32b. By tightening the nut 64, the carrier pin 60 is secured to the second carrier member 32.

The head 61 has a seating surface 61b between a side surface 61a of the head 61 and a side surface 62a of the shaft portion 62. The seating surface 61b is an annular plane perpendicular to the axial direction DA. The seating surface 61b faces the pin support surface 31d. Contact between the seating surface 61b and the pin support surface 31d restricts movement of the carrier pin 60 in the axial direction DA toward the second side. Contact between the seating surface 61b and the pin support surface 31d imparts a clamping force to the first carrier member 31 and the second carrier member 32, thereby securing them together.

A bushing 15 is provided between the external gear 40 and the shaft portion 62. The bushing 15 is disposed between the first carrier member 31 and the second carrier member 32. The bushing 15 is press-fitted onto the shaft portion 62. The outer diameter of the bushing 15 is smaller than the diameter of the through hole 41b. Consequently, a gap is formed between the bushing 15 and the external gear 40. As shown in FIG. 2, the external gear 40 contacts the bushing 15 in the region along the axial direction DA of the through hole 41b, which forms a part of the outer circumferential surface of the bushing 15. Ideally, the external gear 40 and the bushing 15 come into contact along a straight line in the axial direction DA of the through hole 41b. As the external gear 40 oscillates eccentrically, the through holes 41b translate and move in a circular path centered on the pin axis AP relative to the shaft 62 and the bushing 15. Thus, the tangent line between the external gear 40 and the bushing 15 moves in a circumferential direction centered on the pin axis AP along the outer surface of the bushing 15.

Rotation is input to the speed reducer 10, which has the above-described configuration, from a drive means such as a motor. The shaft member 50 may be spline-coupled to a rotation shaft of the drive means. The shaft member 50 is rotated by rotation of the rotation shaft of the drive means. As described above, the rotation of the shaft member 50 causes the external gear 40 to oscillate eccentrically. At this time, the external teeth 45 of the external gear 40 are meshed with the internal teeth 25 of the case 20. Due to the eccentric oscillation of the external gear 40 and the difference in the number of teeth between the external teeth 45 and the internal teeth 25, each time the shaft member 50 rotates one full revolution relative to the carrier 30, an internal tooth 25 that was positioned between a pair of adjacent external teeth 45 shifts from that position by the difference in the number of teeth between the external and internal teeth. That is, during one full revolution of the shaft member 50 relative to the carrier 30, the case 20 rotates relative to the carrier 30 about the rotational axis RA, such that the carrier 30 and the case 20 rotate relative to each other about the rotational axis RA by an angle corresponding to the difference in the number of teeth between the external teeth 45 and the internal teeth 25. When the difference in the number of the external teeth 45 and the internal teeth 25 is one, while the shaft member 50 rotates relative to the carrier 30 a number of times equal to the number of the internal teeth 25, the case 20 rotates one full revolution relative to the carrier 30 about the rotational axis RA. Consequently, the number of rotations input to the shaft member 50 is reduced and output as the relative rotation of the case 20 and the carrier 30. When the case 20 is fixed, the rotation of the carrier 30 is output. Whereas when the carrier 30 is fixed, the rotation of the case 20 is output.

While the speed reducer is in operation, significant forces are applied to the carrier pin. In particular, because the seating surface of the head and the side surface of the shaft portion are perpendicular to each other, stress tends to concentrate at the corners between them. This concentration of stress between the head and the shaft portion creates a risk that the carrier pin may fracture at the portion between them. Therefore, in order to moderate the change in the angle between the seating surface of the head and the side surface of the shaft portion, a concave curved connecting portion with a gradually decreasing width has been provided between the head and the shaft portion. As such a connecting portion, one having an outer contour that follows an arc is widely known.

When the outer contour of the connecting portion follows an arc, the connecting portion has a constant radius of curvature. As the radius of curvature of the connecting portion increases, the curved surface becomes more gradual, and stress concentration in the connecting portion is less likely to occur. However, when the radius of curvature of the connecting portion is large, the area of the seating surface becomes smaller, thereby weakening the axial force of the carrier pin. Conversely, when the radius of curvature of the connecting portion is small, the axial force of the carrier pin can be sufficiently secured, but stress tends to concentrate in the connecting portion. Therefore, it has been difficult to achieve both sufficient axial force of the carrier pin and suppression of stress concentration in the connecting portion.

To address this, in the embodiment, as will be described below, the radius of curvature R1 of the surface at a given position P1 of a connecting portion 65 of the carrier pin 60 differs from the radius of curvature R2 of the surface at another position P2 that is displaced from the position P1 in the axial direction. With the shape of the connecting portion 65 configured in this manner, it is possible to sufficiently secure the axial force of the carrier pin 60 while suppressing stress concentration in the connecting portion 65. Several specific examples of the carrier pin 60 will be described below. Although various specific examples are described, their corresponding constituents, elements and components are denoted by the same reference signs and are not described redundantly.

Note that the carrier pin 60 described below can be applied to the aforementioned speed reducer 10, as described with reference to the specific examples shown in FIGS. 1 and 2. On the other hand, the application of the carrier pin 60 is not limited to the specific examples shown in FIGS. 1 and 2.

In the following description, when the first eccentric member 55A and the second eccentric member 55B are collectively referred to as “eccentric member 55” without distinction, the description regarding “eccentric member 55” applies to both the first eccentric member 55A and the second eccentric member 55B. Similarly, descriptions regarding the “external gear 40” are applicable to both the first external gear 40A and the second external gear 40B.

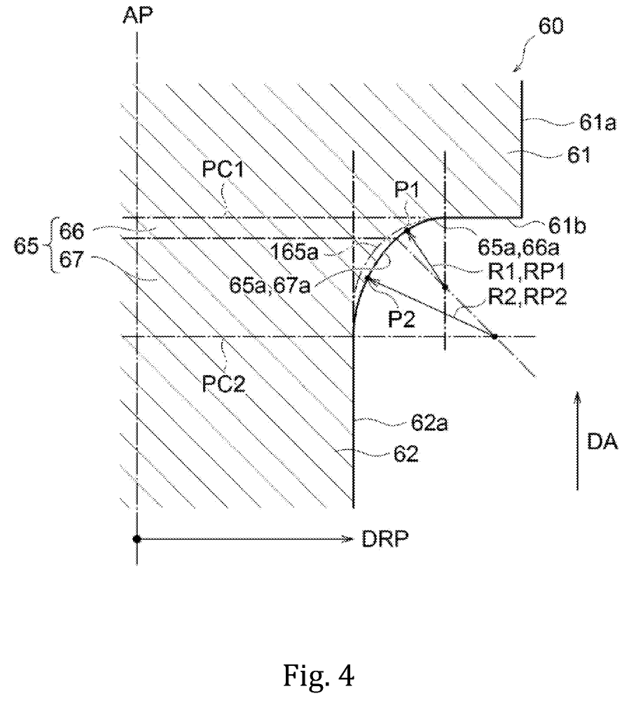

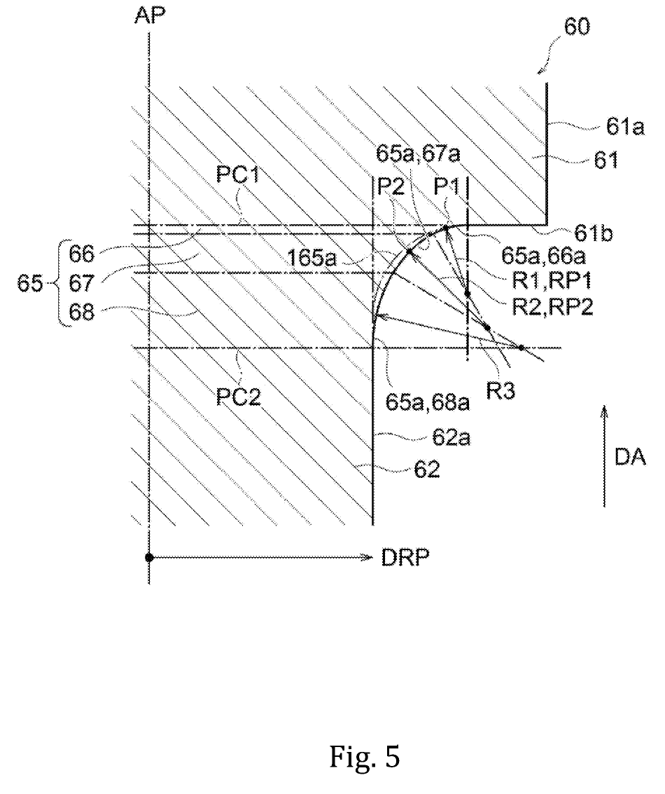

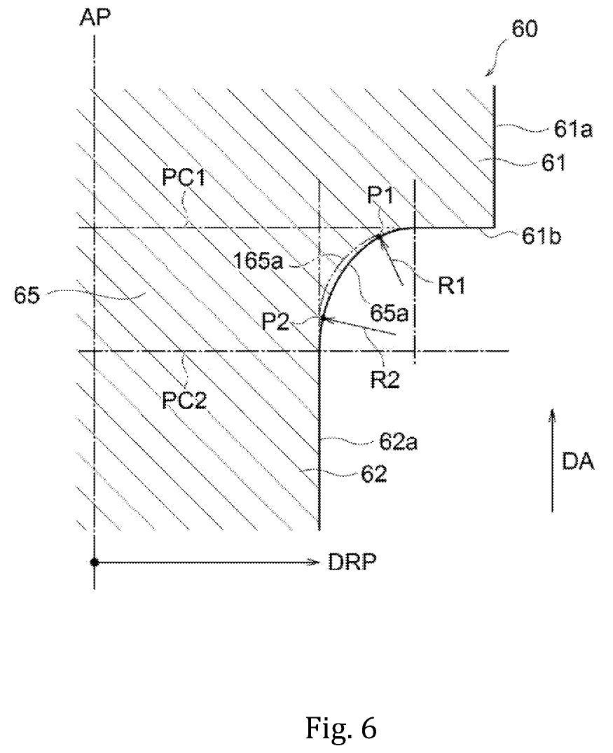

The following sections describe several specific examples of carrier pin 60 with reference to FIGS. 3 - 6. FIG. 3 is a longitudinal sectional view of the carrier pin 60. FIG. 4 is an enlarged partial view of FIG. 3, illustrating a first specific example of the carrier pin 60. FIG. 5 is an enlarged partial view of FIG. 3, illustrating a modification of the first specific example of the carrier pin 60 shown in FIG. 4. FIG. 6 is an enlarged partial view of FIG. 3, illustrating a second specific example of the carrier pin 60.

As described above, the speed reducer 10 includes the case 20, the carrier 30, the external gear 40, the shaft member 50, and the plurality of carrier pins 60. The case 20 has the internal teeth 25. The carrier 30 includes the first carrier member 31 and the second carrier member 32. The carrier 30 is rotatable relative to the case 20. The external gear 40 is disposed between the first carrier member 31 and the second carrier member 32. The external gear 40 has the external teeth 45 that mesh with the internal teeth 25. The external gear 40 is provided with the central hole 41a and the plurality of through holes 41b arranged around the central hole 41a. The shaft member 50 has the eccentric member 55 disposed in the central hole 41a. The shaft member 50 is rotatably supported by the carrier 30. The plurality of carrier pins 60 are inserted in the through holes 41b to connect the first carrier member 31 and the second carrier member 32. Each carrier pin 60 has the head 61 and the shaft portion 62 whose width is smaller than the width of the head 61.

As shown in FIG. 3, each carrier pin 60 further includes the connecting portion 65 that connects the head 61 and the shaft portion 62. The connecting portion 65 is disposed between the head 61 and the shaft portion 62. The surface of the connecting portion 65 is disposed between the seating surface 61b and the side surface 62a of the shaft portion 62. The surface of the connecting portion 65 is connected to the seating surface 61b and the side surface 62a of the shaft portion 62.

As shown in FIGS. 4 - 6, the connecting portion 65 has a concave curved shape whose width gradually decreases. Here, the term “concave curved shape” means that a straight line segment connecting any two points on an outer contour 65a of the connecting portion 65 lies outside the connecting portion 65 at locations other than the two points. In other words, the “concave curved shape” means that, between any two points on the outer contour 65a, the outer contour 65a is situated closer to the pin axis AP than the straight line segment connecting the two points. That is, the term “concave curved shape” means that, when the outer contour 65a is expressed as a function in which an independent variable is "x" and a dependent variable is "y" in a coordinate system in which the connection position between the connecting portion 65 and the shaft portion 62 on the pin axis AP is taken as the origin, the axial direction DA is taken as the x‑axis with the first side in the axial direction DA being positive, and the pin radial direction DRP orthogonal to the pin axis AP is taken as the y‑axis with the outward direction away from the pin axis AP being positive, the slope of the function continuously increases. Stated differently, the second derivative of the function is positive. Note that the outer contour 65a refers to the contour of the connecting portion 65 in a section obtained by cutting the carrier pin 60 with a plane including the pin axis AP.

Accordingly, as the width of the connecting portion 65 gradually decreases from a connection position PC1 with the head 61 toward a connection position PC2 with the shaft portion 62 in the axial direction DA, the inclination of the surface of the connecting portion 65 with respect to the axial direction DA also gradually decreases. Therefore, stress concentration in the portion between the head 61 and the shaft portion 62 can be suppressed.

The surface of the connecting portion 65 may be perpendicular to the axial direction DA at the connection point PC1 with the head 61. That is, the surface of the connecting portion 65 and the seating surface 61b of the head 61 may be connected without a change in angle. This makes it possible to suppress stress concentration between the connecting portion 65 and the head 61.

The surface of the connecting portion 65 may be parallel to the axial direction DA at the connection point PC2 with the shaft portion 62. In other words, the surface of the connecting portion 65 and the side surface 62a of the shaft portion 62 may be connected without a change in angle. This makes it possible to suppress stress concentration between the connecting portion 65 and the shaft portion 62.

As shown in FIGS. 4 - 6, a common feature of all specific examples is that the curvature radius RP1 at the given position P1 of the connecting portion 65 differs from the curvature radius RP2 at another position P2 offset from the position P1 in the axial direction DA. In other words, the curvature radius of the connecting portion 65 is not constant. Because the surface of the connecting portion 65 has multiple different radii of curvature, the degree of freedom in the shape of the connecting portion 65 is increased. Therefore, by designing an optimal shape, it is possible to sufficiently ensure the axial force of the carrier pin 60 while suppressing stress concentration in the connecting portion 65.

Here, the radius of curvature of the surface of the connecting portion 65 at each position thereon refers to the radius of curvature at that position of the outer contour 65a including that position. Furthermore, the given position P1 and the other given position P2 are both included in the single outer contour 65a.

In the example shown in FIGS. 4 - 6, in the axial direction DA, the given position P1 is situated between the head 61 and the other position P2. That is, in the illustrated example, the given position P1 and the other position P2 are arranged in this order from the first side toward the second side in the axial direction DA. In this case, as shown in FIGS. 4 - 6, the radius of curvature RP1 at the given position P1 may be smaller than the radius of curvature RP2 at the other position P2.

In FIGS. 4 - 6, an outer contour 165a of the connecting portion having a constant radius of curvature is shown by a two‑dot chain line as a conventional example. In both the conventional example and the specific examples of the embodiment, the width of the head, the width of the shaft portion, and the length of the seating surface are the same. As shown in FIGS. 4 - 6, the radius of curvature of the connecting portion 65 at the connection position PC1 between the connecting portion 65 and the head 61 is smaller than the radius of curvature of the connecting portion in the conventional example. The radius of curvature of the connecting portion 65 at the connection position PC2 between the connecting portion 65 and the shaft portion 62 is larger than the radius of curvature of the connecting portion in the conventional example. Therefore, in the examples shown in FIGS. 4 - 6, by reducing the radius of curvature at the connection point PC1, where stress is low, the area of the seating surface 61b can be secured; and by increasing the radius of curvature at the connection point PC2, where stress is high, stress concentration at the connecting portion 65 can be alleviated. Therefore, by setting the relationship between the position in the connecting portion 65 and the radius of curvature as described above, it is possible to sufficiently secure the area of the seating surface 61b and thereby sufficiently secure the axial force of the carrier pin 60, while suppressing stress concentration in the connecting portion 65.

As shown in FIG. 3, a width W2 of the shaft portion 62 may be 68 % or more of a width W1 of the head 61. When the width W2 of the shaft portion 62 is larger relative to the width W1 of the head 61, the area of the seating surface 61b becomes smaller. In the embodiment, even when the width W2 of the shaft portion 62 is 68 % or more of the width W1 of the head 61, the area of the seating surface 61b can be sufficiently secured to ensure adequate axial force of the carrier pin 60, while also suppressing stress concentration in the connecting portion 65.

Referring primarily to FIGS. 4 and 5, a first specific example of the carrier pin 60 and a modified example thereof will be described.

In the embodiment of FIG. 4, the connecting portion 65 includes a first connecting portion 66 and a second connecting portion 67. In the axial direction DA, the first connecting portion 66 is disposed between the head 61 and the second connecting portion 67. The first connecting portion 66 and the second connecting portion 67 may be adjacent to each other in the axial direction DA. The first connecting portion 66 may be adjacent to the head 61 in the axial direction DA. The second connecting portion 67 is disposed between the first connecting portion 66 and the shaft portion 62. The second connecting portion 67 may be adjacent to the shaft portion 62 in the axial direction DA.

The first connecting portion 66 has a first outer contour 66a. The first outer contour 66a follows an arc having a first radius of curvature R1. The first connecting portion 66 has the first radius of curvature R1. The second connecting portion 67 has a second outer contour 67a. The second outer contour 67a follows an arc having a second radius of curvature R2. The second connecting portion 67 has the second radius of curvature R2. The second radius of curvature R2 is different from the first radius of curvature R1. In the specific example of FIG. 4, the first radius of curvature R1 is smaller than the second radius of curvature R2.

As shown in the modified example of FIG. 5, the connecting portion 65 may include a third connecting portion 68 in addition to the first connecting portion 66 and the second connecting portion 67. The third connecting portion 68 is disposed between the second connecting portion 67 and the shaft portion 62. The third connecting portion 68 may be adjacent to both the second connecting portion 67 and the shaft portion 62. The third connecting portion 68 has a third outer contour 68a along an arc having a third radius of curvature R3. The third radius of curvature R3 is greater than the second radius of curvature R2.

In the specific examples of FIGS. 4 and 5, by forming the outer contour 65a by combining multiple arcs with different radii of curvature, it is possible to sufficiently ensure the axial force of the carrier pin 60 while suppressing stress concentration in the connecting portion 65.

In the specific example of FIG. 4, the given position P1 is any position on the first connecting portion 66. The other given position P2 is any position on the second connecting portion 67. Thus, the radius of curvature RP1 of the surface at the given position P1 is the same as the first radius of curvature R1. The radius of curvature RP2 of the surface at the other given position P2 is the same as the second radius of curvature R2. Thus, the radius of curvature RP1 of the surface at the given position P1 is smaller than the radius of curvature RP2 of the surface at the other given position P2.

In the specific example of FIG. 5, the given position P1 may be any position on the first connecting portion 66 as in the specific example of FIG. 4. The other given position P2 may be any position on the second connecting portion 67. In this example, the radius of curvature RP1 of the surface at the given position P1 is the same as the first radius of curvature R1. In this example, the radius of curvature RP2 of the surface at the other given position P2 is the same as the second radius of curvature R2. Thus, the radius of curvature RP1 of the surface at the given position P1 is smaller than the radius of curvature RP2 of the surface at the other given position P2.

Alternatively, in the specific example shown in FIG. 5, the given position P1 may be any position on the first connecting portion 66, and the other given position P2 may be any position on the third connecting portion 68. Alternatively, in the specific example of FIG. 5, the given position P1 may be any position on the second connecting portion 67, and the other given position P3 may be any position on the third connecting portion 68. In these examples as well, the radius of curvature RP1 of the surface at the given position P1 is smaller than the radius of curvature RP2 of the surface at the other given position P2.

Referring to FIG. 6, a second specific example of the carrier pin 60 will be described.

In the specific example of FIG. 6, the radius of curvature of the connecting portion 65 decreases from the shaft portion 62 toward the head 61 in the axial direction DA. In the examples of FIGS. 4 and 5, the radius of curvature of the connecting portion 65 changes stepwise. The radius of curvature of the connecting portion 65 may instead change continuously. The outer contour 65a may follow an elliptical arc. Even in this specific example of FIG. 6, it is possible to sufficiently secure the axial force of the carrier pin 60 while suppressing stress concentration in the connecting portion 65.

As shown in FIG. 6, when the given position P1 and the other position P2 are arbitrarily set such that, in the axial direction DA, the given position P1 is situated between the head 61 and the other position P2, the radius of curvature RP1 at the given position P1 becomes smaller than the radius of curvature RP2 at the other position P2.

As described above, the speed reducer 10 in the embodiment includes: the case 20 having the internal teeth 25; the carrier 30 including the first carrier member 31 and the second carrier member 32, the carrier 30 being rotatable relative to the case 20; the external gear 40 disposed between the first carrier member 31 and the second carrier member 32, the external gear 40 having the external teeth 45 that mesh with the internal teeth 25, and the external gear 40 having the central hole 41a and the plurality of through holes 41b arranged around the central hole 41a; the shaft member 50 having the eccentric member 55 disposed in the central hole 41a, the shaft member 50 being rotatably supported by the carrier 30; and the plurality of carrier pins 60 inserted in the through holes 41b to connect the first carrier member 31 and the second carrier member 32. Each carrier pin 60 includes a head 61, a shaft portion 62 whose width is smaller than the width of the head 61, and a connecting portion 65, the connecting portion having a concave curved shape that connects the head 61 and the shaft portion 62 and whose width gradually decreases. The radius of curvature RP1 of the surface of the connecting portion 65 at the given position P1 differs from the radius of curvature RP2 of the surface of the connecting portion 65 at the other given position P2 displaced from position P1 in the axial direction DA. According to this embodiment, sufficient axial force of the carrier pin 60 can be ensured while suppressing stress concentration in the connecting portion 65.

While the foregoing has described the embodiment with reference to specific examples, these specific examples are not intended to limit the embodiment. The foregoing embodiment can be implemented in various other specific forms and is susceptible to omission, replacement, modification and addition of various elements thereof within the purport of the invention.

For example, in the specific example of FIG. 4, the outer contour 65a is formed by two arcs having different radii of curvature. In the specific example of FIG. 5, the outer contour 65a is formed by three arcs having different radii of curvature. However, the number of arcs having different radii of curvature that form the outer contour 65a is not limited to these. The number of arcs having different radii of curvature that form the outer contour 65a may be four or more, five or more, six or more, or seven or more.

The foregoing embodiments disclosed herein describe a plurality of physically separate constituent parts. They may be combined into a single part, and any one of them may be divided into a plurality of physically separate constituent parts. Irrespective of whether or not the constituent parts are integrated, they are acceptable as long as they are configured to attain the object of the invention.

What is claimed is:

1. A speed reducer comprising:
a case having internal teeth;
a carrier including a first carrier member and a second carrier member, the carrier being rotatable relative to the case;
an external gear disposed between the first carrier member and the second carrier member, the external gear having external teeth that mesh with the internal teeth, and the external gear having a central hole and a plurality of through holes arranged around the central hole;
a shaft member having an eccentric member disposed in the central hole, the shaft member being rotatably supported by the carrier; and
a plurality of carrier pins inserted in the through holes to connect the first carrier member and the second carrier member, each carrier pin including a head, a shaft portion whose width is smaller than a width of the head, and a connecting portion, the connecting portion having a concave curved shape that connects the head and the shaft portion and whose width gradually decreases, wherein a radius of curvature of a surface of the connecting portion at a given position differs from a radius of curvature of a surface of the connecting portion at another given position displaced from the given position in an axial direction.

2. The speed reducer of claim 1, wherein the given position is situated between the head and the other given position in the axial direction, and
wherein the radius of curvature of the surface at the given position is smaller than the radius of curvature of the surface at the other given position.

3. The speed reducer of claim 1, wherein the connecting portion includes a first connecting portion having an outer contour along an arc, and a second connecting portion having an outer contour along an arc with a radius of curvature different from a radius of curvature of the first connecting portion,
wherein the first connecting portion is disposed between the head and the second connecting portion in the axial direction, and
wherein the radius of curvature of the first connecting portion is smaller than the radius of curvature of the second connecting portion.

4. The speed reducer of claim 1, wherein the radius of curvature of the connecting portion decreases in the axial direction from the shaft portion toward the head.

5. The speed reducer of claim 1, wherein the width of the shaft portion is 68% or more of the width of the head.
